(19) United States
(12) Patent Application Publication
(10) Pub. No.: US 2020/0364764 A1
(43) Pub. Date: Nov. 19, 2020

(54) Managing Preferences of Multiple Organizations Utilizing Shared Platform

(71) Applicant: salesforce.com, inc., San Francisco, CA (US)

(72) Inventors: Mathias STÖDTLER, Jena (DE); Christian Andreas MEYER, Weimar (DE)

(21) Appl. No.: 16/411,352

(22) Filed: May 14, 2019

(51) Int. Cl. G06Q 30/06

(52) U.S. Cl. CPC G06Q 30/0619; G06Q 30/0635

(57) ABSTRACT

Systems and methods provide for managing preferences of multiple tenant organizations utilizing a shared computer platform. The systems and methods receive a current data item, identify one of the multiple tenant organizations that is associated with the current data item, and determine whether the identified tenant organization utilizes a process that can be performed by the shared computer platform on the current data item. If the identified tenant organization utilizes the process, the systems and methods cause the shared platform to perform the process on the current data item to generate processed data and enable a preference for the shared computer platform to perform the process on subsequent data items associated with the identified tenant organization. The systems and methods maintain the preference for each such subsequent data item as long as the identified tenant organization utilizes the process within a predetermined interval after a prior data item.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to a computing device, and more specifically to systems and methods for managing preferences of multiple organizations utilizing a shared platform.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Multi-tenant cloud-based architectures have been developed to improve collaboration, integration, and community-based cooperation without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). In a multi-tenant environment, various features or functionality are loaded or made available to the different tenant organizations. But not every tenant organization uses the platform in the same way and with the same features. For example, one tenant organization may utilize a particular feature (which can be computer and cloud platform resource intensive), whereas another tenant organization (which has its own processes or procedures for the same feature) does not. The tenant organization actually using the feature may be provided with an enhanced experience, but the tenant organization not using the feature may not care. Dedicating cloud platform resources and providing such feature to every tenant organization—even those who do not wish to use it—may not be feasible or desired, for example, because it unnecessarily consumes platform resources (such as processing, network, or storage capacity).

### BRIEF DESCRIPTION OF THE DRAWINGS

FIG. 1 illustrates a simplified block diagram of an example environment according to some embodiments.

FIG. 2 illustrates a simplified block diagram of another example environment according to some embodiments.

FIG. 3 illustrates a simplified block diagram of a system for managing preferences of multiple organizations utilizing a shared platform, according to some embodiments.

FIGS. 4 and 5 illustrate simplified diagrams of a method or process flow for managing preferences of multiple organizations utilizing a shared platform, according to some embodiments.

In the figures, elements having the same designations have the same or similar functions.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one skilled in the art. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### Overview

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture, therefore, allows convenient and cost-effective sharing of similar application features between multiple sets of users or tenant organizations. For example, a multi-tenant, cloud-based platform can be used to support tenant organizations' provision for electronic commerce (e-commerce), e.g., enabling them to act as merchants to offer and sell products and services on the Internet.

But not every tenant organization uses the platform in the same way and with the same features. One tenant organization may utilize a particular feature (which can be computer and cloud platform resource intensive), whereas another tenant organization does not. In the example of a multi-tenant platform supporting e-commerce, the platform may have a feature or function of order export extensible markup language (XML) preparation. The cloud provider offers a capability to get the XML for a certain data entity. Creating that is expensive (e.g., potentially in processing resources) and it is in the interest of the provider as well as the tenant organizations that the creation procedure is executed only if necessary. Since it's an expensive process, this can be optimized in an asynchronous process to provide the XML quicker. This asynchronous process should be executed for those tenant organizations requesting XML data only. Because the volume of e-commerce continues to increase, allocating cloud computing, processing, and storage resources of the platform and network to provide such feature of asynchronous XML order export to every tenant organization—even those who do not use it—is neither feasible nor an optimal use of resources. Thus, for scaling and other operational reasons in a multi-tenant platform, it may be desirable to activate and selectively maintain certain optimizations or features for some tenant organization who use them, while not activating such features for other tenant organizations who do not use them, thereby minimizing the impact to the platform resources in general.

To this end, according to some embodiments, in a multi-tenant platform that is shared or used by multiple tenant organizations, systems and methods are provided to automatically activate (self-activate) for a tenant organization a feature that may be resource intensive (e.g., in terms of processing power, storage capacity, network utilization, etc.). The systems and methods monitor the activity of the tenant organization, for example, over a certain period of time or a predetermined interval. If the tenant organization continues to use or access the feature during that period, the systems and methods allow the feature to continue, thus providing an enhanced experience for that tenant organization (e.g., more rapid delivery of processed order data). However, if the tenant organization does not use or access the feature again during the specified interval, the feature is deactivated or disabled until the next time that the tenant organization uses. In this way, the systems and methods balance performance for some tenant organizations with network and processing utilization of the multi-tenant platform as a whole.

### Example Environment

The system and methods of the present disclosure can include, incorporate, or operate in conjunction with or in the environment of a database, which in some embodiments can be implemented as a multi-tenant, cloud-based architecture.

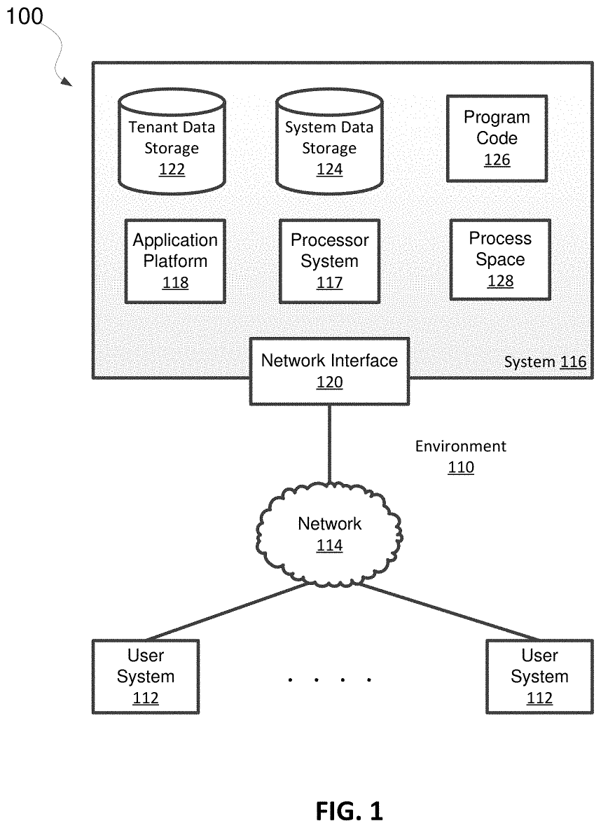

FIG. 1 illustrates a block diagram of an example environment 110 according to some embodiments. Environment 110 may include user systems 112, network 114, system 116, processor system 117, application platform 118, network interface 120, tenant data storage 122, system data storage 124, program code 126, and process space 128 for executing database system processes and tenant-specific processes, such as running applications as part of an application hosting service. In other embodiments, environment 110 may not have all of the components listed and/or may have other elements instead of, or in addition to, those listed above.

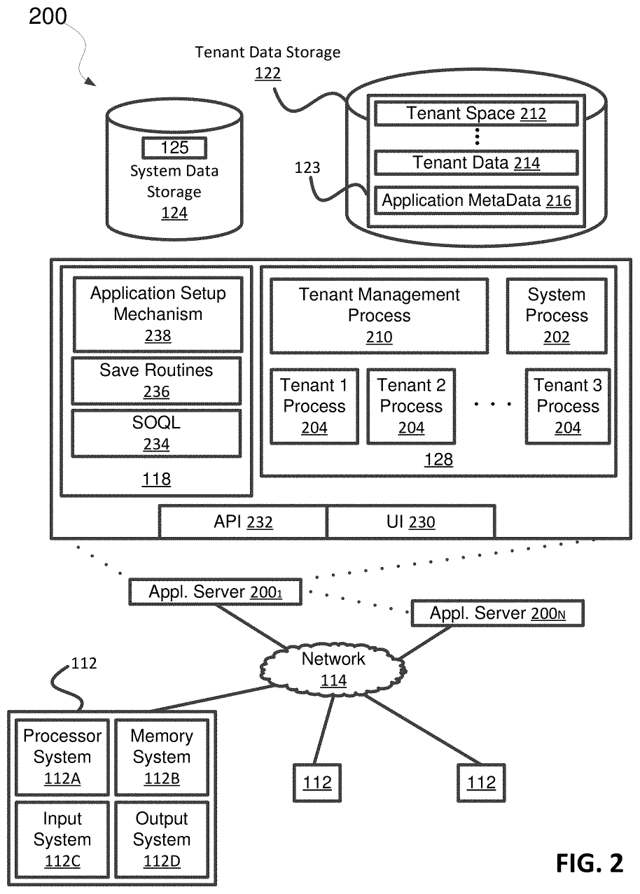

In some embodiments, the environment 110 is an environment in which an on-demand database service exists. A user system 112 may be any machine or system that is used by a user to access a database user system. For example, any of user systems 112 can be a handheld computing device, a mobile phone, a laptop computer, a notepad computer, a work station, and/or a network of computing devices. As illustrated in FIG. 1 (and in more detail in FIG. 2) user systems 112 might interact via a network 114 with an on-demand database service, which is system 116.

An on-demand database service, such as that which can be implemented using the system 116, is a service that is made available to users outside of the enterprise(s) that own, maintain or provide access to the system 116. As described above, such users do not need to necessarily be concerned with building and/or maintaining the system 116. Instead, resources provided by the system 116 may be available for such users' use when the users need services provided by the system 116—e.g., on the demand of the users. Some on-demand database services may store information from one or more tenants into tables of a common database image to form a multi-tenant database system (MTS). Accordingly, the “on-demand database service 116” and the “system 116” will be used interchangeably herein. The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image may include one or more database objects. A relational database management system (RDBMS) or the equivalent may execute storage and retrieval of information against the database object(s).

The application platform 118 may be a framework that allows the applications of system 116 to run, such as the hardware and/or software infrastructure, e.g., the operating system. In an embodiment, on-demand database service 116 may include an application platform 118 that enables creating, managing, and executing one or more applications developed by the provider of the on-demand database service, users accessing the on-demand database service via user systems 112, or third-party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system has the capacities allotted to that salesperson. However, while an administrator is using that user system 112 to interact with system 116, that user system 112 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 114 is any network or combination of networks of devices that communicate with one another. For example, the network 114 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the “Internet” with a capital “I” that network will be used in many of the examples herein. However, it should be understood that the networks that the present embodiments might use are not so limited, although TCP/IP is a frequently implemented protocol.

The user systems 112 might communicate with system 116 using TCP/IP and, at a higher network level, use other common Internet protocols to communicate, such as hypertext transfer protocol (HTTP), file transfer protocol (FTP), Andrew file system (AFS), wireless application protocol (WAP), etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least for the users that are accessing that server, each of the plurality of servers has access to the MTS data; however, other alternative configurations may be used instead. In some implementations, in global applications, HTTP server may be implemented with remote procedure call (RPC) or global RPC (gRPC) where several continental servers such or gRPC servers are being monitored by a main CRM server (e.g., CRM system 116).

In some embodiments, the system 116, shown in FIG. 1, implements a web-based customer relationship management (CRM) system. For example, in one embodiment, system 116 includes application servers configured to implement and execute CRM software applications as well as provide related data, code, forms, webpages and other information to and from user systems 112 and to store to, and retrieve from, a database system related data, objects, and web page content. With a MTS, data for multiple tenants may be stored in the same physical database object. However, tenant data typically is arranged so that data of one tenant is kept logically separate from that of other tenants so that one tenant does not have access to another tenant's data, unless such data is expressly shared. In certain embodiments, the system 116 implements applications other than, or in addition to, a CRM application. For example, system 116 may provide tenant access to multiple hosted (standard and custom) applications, including a CRM application. User (or third-party developer) applications, which may or may not include CRM, may be supported by the application platform 118, which manages creation, storage of the applications into one or more database objects, and execution of the applications in a virtual machine in the process space of the system 116.

One arrangement for elements of the system 116 is shown in FIG. 1, including the network interface 120, the application platform 118, the tenant data storage 122 for tenant data 123, the system data storage 124 for system data 125 accessible to system 116 and possibly multiple tenants, the program code 126 for implementing various functions of the system 116, and the process space 128 for executing MTS system processes and tenant-specific processes, such as running applications as part of an application hosting service. Additional processes that may execute on system 116 include database indexing processes.

Several elements in the system shown in FIG. 1 includes conventional, well-known elements that are explained only briefly here. For example, each of the user systems 112 could include a desktop personal computer, workstation, laptop, notepad computer, personal digital assistant (PDA), cellphone, or any wireless access protocol (WAP) enabled device or any other computing device capable of interfacing directly or indirectly to the Internet or other network connection. Each of the user systems 112 typically runs an HTTP client, e.g., a browsing program, such as Microsoft's Internet Explorer browser, Netscape's Navigator browser, Opera's browser, or a WAP-enabled browser in the case of a cell phone, notepad computer, PDA or other wireless device, or the like, allowing a user (e.g., subscriber of the MTS) of the user systems 112 to access, process, and view information, pages, and applications available to it from the system 116 over the network 114. Each of the user systems 112 also typically includes one or more user interface devices, such as a keyboard, mouse, trackball, touch pad, touch screen, pen or the like, for interacting with a graphical user interface (GUI) provided by the browser on a display (e.g., a monitor screen, liquid crystal display (LCD) monitor, light emitting diode (LED) monitor, organic light emitting diode (OLED) monitor, etc.) in conjunction with pages, forms, applications, and other information provided by the system 116 or other systems or servers. For example, the user interface device can be used to access data and applications hosted by system 116, and to perform searches on stored data, and otherwise, allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each of the user systems 112 and all of its components are operator configurable using applications, such as a browser, including computer code run using a central processing unit (CPU) such as an Intel Pentium® processor or the like. Similarly, system 116 (and additional instances of an MTS, where more than one is present) and all of their components might be operator configurable using application(s) including computer code to run using a CPU such as the processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring the system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a read-only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

According to one embodiment, the system 116 is configured to provide webpages, forms, applications, data, and media content to the user (client) systems 112 to support the access by the user systems 112 as tenants of the system 116. As such, the system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., object-oriented database management system (OODBMS) or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates the environment 110, which may be used to implement embodiments described herein. FIG. 2 further illustrates elements of system 116 and various interconnections, according to some embodiments. FIG. 2 shows that each of the user systems 112 may include a processor system 112A, a memory system 112B, an input system 112C, and an output system 112D. FIG. 2 shows the network 114 and the system 116. FIG. 2 also shows that the system 116 may include the tenant data storage 122, the tenant data 123, the system data storage 124, the system data 125, a user interface (UI) 230, an application program interface (API) 232, a Salesforce.com object query language (SOQL) 234, save routines 236, an application setup mechanism 238, applications servers 200₁-200_{N}, a system process space 202, tenant process spaces 204, a tenant management process space 210, a tenant storage area 212, a user storage 214, and application metadata 216. In other embodiments, environment 110 may not have the same elements as those listed above and/or may have other elements instead of, or in addition to, those listed above.

The user systems 112, the network 114, the system 116, the tenant data storage 122, and the system data storage 124 were discussed above in FIG. 1. Regarding the user systems 112, the processor system 112A may be any combination of one or more processors. The memory system 112B may be any combination of one or more memory devices, short term, and/or long term memory. The input system 112C may be any combination of input devices, such as one or more keyboards, mice, trackballs, scanners, cameras, and/or interfaces to networks. The output system 112D may be any combination of output devices, such as one or more monitors, printers, and/or interfaces to networks. As shown in FIGS. 1 and 2, the system 116 may include the network interface 120 (of FIG. 1) implemented as a set of HTTP application servers 200, the application platform 118, the tenant data storage 122, and the system data storage 124. Also shown is system process space 202, including individual tenant process spaces 204 and the tenant management process space 210. Each application server 200 may be configured to access the tenant data storage 122 and the tenant data 123 therein, and the system data storage 124 and the system data 125 therein to serve requests of the user systems 112. The tenant data 123 might be divided into individual tenant storage areas 212, which can be either a physical arrangement and/or a logical arrangement of data. Within each tenant storage area 212, the user storage 214 and the application metadata 216 might be similarly allocated for each user. For example, a copy of a user's most recently used (MRU) items might be stored to the user storage 214. Similarly, a copy of MRU items for an entire organization that is a tenant might be stored to the tenant storage area 212. The UI 230 provides a user interface and the API 232 provides an application programmer interface to the system 116 resident processes and to users and/or developers at the user systems 112. The tenant data and the system data may be stored in various databases, such as one or more Oracle™ databases.

The application platform 118 includes an application setup mechanism 238 that supports application developers' creation and management of applications, which may be saved as metadata into tenant data storage 122 by the save routines 236 for execution by subscribers as one or more tenant process spaces 204 managed by the tenant management process space 210, for example. Invocations to such applications may be coded using SOQL 234 that provides a programming language style interface extension to the API 232. Some embodiments of SOQL language are discussed in further detail in U.S. Pat. No. 7,730,478, filed September, 2007, entitled, “Method and System For Allowing Access to Developed Applications Via a Multi-Tenant On-Demand Database Service,” which is incorporated herein by reference. Invocations to applications may be detected by one or more system processes, which manage retrieving the application metadata 216 for the subscriber, making the invocation and executing the metadata as an application in a virtual machine.

Each application server 200 may be communicably coupled to database systems, e.g., having access to the system data 125 and the tenant data 123, via a different network connection. For example, one application server 200₁ might be coupled via the network 114 (e.g., the Internet), another application server 200_{N-1} might be coupled via a direct network link, and another application server 200_{N} might be coupled by yet a different network connection. TCP/IP are typical protocols for communicating between application servers 200 and the database system. However, it will be apparent to one skilled in the art that other transport protocols may be used to optimize the system depending on the network connection used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between the application servers 200 and the user systems 112 to distribute requests to the application servers 200. In one embodiment, the load balancer uses a least connections algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, the system 116 is multi-tenant, wherein the system 116 handles storage of, and access to, different objects, data and applications across disparate users and organizations.

As an example of storage, one tenant might be a company that employs a sales force where each salesperson uses the system 116 to manage his or her sales process. Thus, a user might maintain contact data, leads data, customer follow-up data, performance data, goals and progress data, etc., all applicable to that user's personal sales process (e.g., in the tenant data storage 122). In an example of a MTS arrangement, since all the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all the users for a given organization that is a tenant. Thus, there might be some data structures managed by the system 116 that are allocated at the tenant level while other data structures might be managed at the user level. Because a MTS might support multiple tenants including possible competitors, the MTS should have security protocols that keep data, applications, and application use separate. Also, because many tenants may opt for access to a MTS rather than maintain their own system, redundancy, up-time, and backup are additional functions that may be implemented in the MTS. In addition to user-specific data and tenant-specific data, the system 116 might also maintain system level data usable by multiple tenants or other data. Such system level data might include industry reports, news, postings, and the like that are sharable among tenants.

In certain embodiments, the user systems 112 (which may be client systems) communicate with the application servers 200 to request and update system-level and tenant-level data from the system 116 that may require sending one or more queries to the tenant data storage 122 and/or the system data storage 124. The system 116 (e.g., an application server 200 in the system 116) automatically generates one or more structured query language (SQL) statements (e.g., one or more SQL queries) that are designed to access the desired information. The system data storage 124 may generate query plans to access the requested data from the database. In some examples, the system 116 may use MySQL relational database management system statements to access the desired information.

In a database system, such as system 116 shown and described with respect to FIGS. 1 and 2, data or information may be organized or arranged in categories or groupings. Each database can generally be viewed as a collection of objects, such as a set of logical tables, containing data fitted into predefined categories. A “table” is one representation of a data object and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields.

In a CRM system, for example, these categories or groupings can include various standard entities, such as account, contact, lead, opportunity, group, case, knowledge article, etc., each containing pre-defined fields. For example, a CRM database may include a table that describes a customer with fields for basic contact information such as name, address, phone number, fax number, etc. Another table might describe a purchase order, including fields for information such as customer, product, sale price, date, etc. In some MTS, standard entity tables might be provided for use by all tenants.

In some MTSs, tenants may be allowed to create and store custom objects, or they may be allowed to customize standard entities or objects, for example by creating custom fields for standard objects, including custom index fields. Systems and methods for creating custom objects as well as customizing standard objects in an MTS are described in further detail in U.S. Pat. No. 7,779,039, filed Apr. 2, 2004, entitled “Custom Entities and Fields in a Multi-Tenant Database System,” which is incorporated herein by reference. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

In some embodiments, the multi-tenant platform or system 116, such as described with respect to FIGS. 1 and 2, can be used to support the provision of electronic commerce (e-commerce) services, for one or more of the tenant organizations. In such embodiments, for example, the system 116 can be used to host and serve information for products, services, catalogs, pricing, etc. for products and service offered by various tenant organizations. This information can be uploaded, updated, modified, etc., by the tenant organizations using, for example, respective user systems 112, and stored or maintained in, for example, the tenant data storage 122. One or more applications running in system 116, for example, in application servers 200, can provide or support the website interface for the e-commerce, where the tenant organizations act as merchants to offer, sell, take orders, etc. for their respective products and services. Potential and actual buyers of such products and services may, using respective user systems 112, view the information and place orders for the products and services. System 116 can store the order information, for example, in tenant data storage 122, from which the tenant organizations may retrieve so that they can fulfill the orders.

### Managing Preferences of Multiple Organizations Utilizing Shared Platform

The multi-tenant platform or system 116, as described with respect to FIGS. 1 and 2, may support or provide various functionalities or features to support, facilitate, or enhance the experience of tenant organizations. In the example of a multi-tenant platform supporting e-commerce, the system 116 may provide a feature such as order export processing, in which the raw order information that is placed or stored into the tenant data storage 122 can be processed and formatted into extensible markup language (XML) for more rapid export, delivery, transfer, and/or processing by the respective tenant organization. In some embodiments, the feature for order export processing may be performed at the time that the respective tenant organization makes a request for the order data—this would be considered “synchronous” processing. In some embodiments, the order export processing may be performed prior to the time that the respective tenant organization makes a request for the order data—this would be considered “asynchronous” processing. Some features or functions can be resource intensive, for example, with respect to processing power, storage capacity, network utilization, etc. of the shared multi-tenant platform 116. In some embodiments, this is potentially the case for XML order export processing.

Not every tenant organization using the shared platform or system 116 will utilize or take advantage of every feature and function that is available. In the example of the multi-tenant platform supporting e-commerce, it is possible that smaller tenant organizations might utilize the XML order export processing to speed up the delivery, transfer, and processing of the order data. On the other hand, it is possible that larger tenant organizations may not use or want the XML order export processing because they have their own processes or procedures for processing the order information, for example, at their own computer systems; in such case, they may prefer to obtain the raw order data rather than processed order data. In other words, different tenant organizations may have different preferences as to the various features and functions, performance optimizations, etc. provided by the shared system 116.

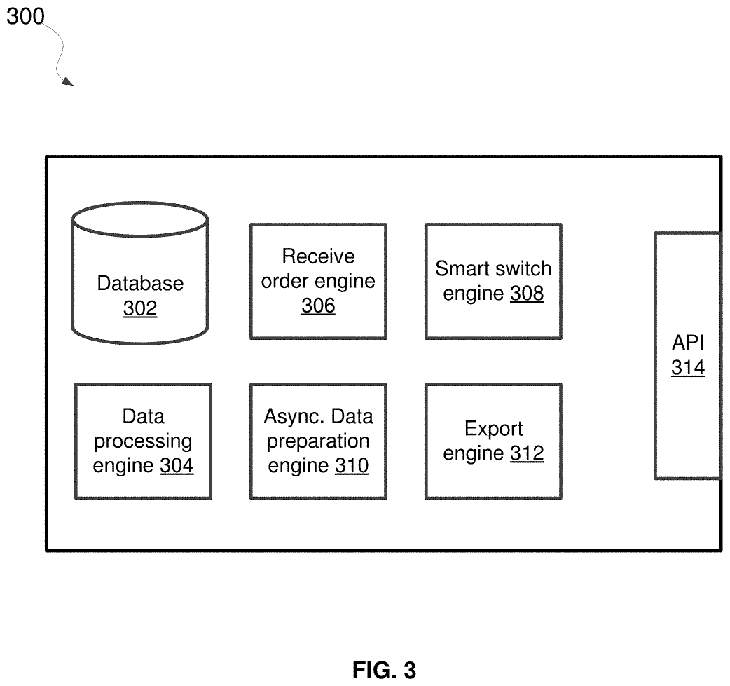

According to embodiments of the present disclosure, systems and methods are provided for managing the preferences of multiple tenant organizations utilizing a shared platform, such as system 116 described with respect to FIGS. 1 and 2. Examples of such embodiments are disclosed with reference to FIGS. 3 to 5.

FIG. 3 illustrates a simplified block diagram of a system 300 for managing preferences of multiple organizations utilizing a shared platform, according to some embodiments. In some embodiments, system 300 provides a self-managed asynchronous order export processing feature to tenant organizations of a multi-tenant shared platform such as a CRM system 116.

According to some embodiments, system 300 may be consistent with systems 100 and 200 as described with reference in FIGS. 1 and 2. According to some embodiments, system 300 may include or be provided with functions and methods to enable tenant organizations using a multi-tenant platform in a CRM system such as that described with reference to FIGS. 1 and 2 with the self-managed asynchronous processing feature.

In a multi-tenant shared platform, such as that described with reference to FIGS. 1 and 2, system 300 may be implemented in a multi-tenant platform to provide or support electronic commerce (e-commerce), where one or more tenant organizations act as merchants to sell, offer, and trade products or services on the Internet. In some embodiments, at least a portion, up to all, of system 300 may be implemented or incorporated, in systems 100 and 200, such as, for example, the multi-tenant system 116. In a database system, such as system 116, tenant organizations can interact with and access the multi-tenant database, for example, using respective user systems 112, to host and support the e-commerce services, including uploading, storing, maintaining, processing, retrieving their catalogs, product or service information, pricing, order data, etc. Customers or shoppers at the tenant organizations' e-commerce sites may use computing devices such as user system 112 to access the tenant organization's web store on the Internet to view and purchase products, services, etc.

In some embodiments, system 300 may include a database 302, a data processing engine 304, a receive order engine 306, a smart switch engine 308, an asynchronous data preparation engine 310, an export engine 312, and an application programming interface (API) 314. Each of these engines 304-312, API 314, and database 302 may support or serve one or more tenant organizations of the shared platform 116. In some embodiments, each of the engines 304-312, API 314, and database 302 may be implemented with suitable computer hardware and/or software to provide the functionality described herein.

Database 302 may be used to store, maintain, host, or serve information for products, services, catalogs, pricing, etc. for products and service offered by various tenant organizations for their e-commerce services. Database 302 may also be used to receive and store information or data for orders made by customers or shoppers for the tenant organizations. This information can be uploaded, updated, modified, retrieved, etc., by the tenant organizations or shoppers using, for example, respective user systems 112, and interacting through, for example, API 314. In some embodiments, database 302 can be implemented or incorporated, in whole or in part, in a cloud-based database such as tenant data storage 122, system data storage 124, etc. (FIGS. 1 and 2) which are shared among and accessible by multiple tenant organizations of a multi-tenant platform.

Receive order engine 306 may include or be provided with functions, procedures, processes to receive orders from one or more shoppers and store their order data in database 302. In some examples, shoppers may use a computing device (e.g., user system 112 such as that described with reference to FIGS. 1 and 2) to order or purchase a product or a service offered by a tenant organization (e.g., through the tenant organization's e-commerce site or web store). When a shopper orders a product or a service offered by a tenant organization (e.g., a merchant), the receive order engine 306 receives the order and stores the order data of the product or the service in the database 302. In some examples, the receive order engine 306 receives the order of a shopper when the shopper enters the order along with payment information and the tenant organization has verified and captured the payment information. In some embodiments, receive order engine 306 may cause the order data to be stored in database 302 in raw or unprocessed form.

Data processing engine 304 may include, provide, or support the computerized functions and algorithms for various features. In some examples, data processing engine 304 may include, provide, or support the computerized functions and algorithms to, among other things, process shoppers' order data and to convert the customers' order data into a form of data or information so that it is more readily or conveniently understand and/or delivered or transferred, for example, across or through the Internet, to respective tenant organizations. In some examples, data processing engine 304 may process the customers' raw order data to generate an XML report or document of the order data. The XML report or document of the order data can be delivered to or downloaded by a respective tenant organization, and used for order fulfillment (e.g., to deliver the ordered product to the shopper). The XML report may generalize, simplify, and unify the order data formats of the tenant organization across the Internet. The XML report of the order data may include, for each order, information about the shopper (e.g., name, email, telephone number), the shopper's shipping address, the order shipping method, payment information (e.g., credit card and billing address), and/or the like. In some embodiments, one or more features or functions provided by the data processing engine 304 and/or other components of system 300 may be optional—i.e., not every tenant organization to the shared platform may want to utilize the feature or function.

The processing performed by data processing engine 304 can be triggered or initiated upon different events. In some embodiments, for example, the feature or function for order export processing may be performed at the time that the respective tenant organization makes a request for the order data—this would be considered “synchronous” processing. In some embodiments, the order export processing may be performed prior to the time that the respective tenant organization makes a request for the order data—this would be considered “asynchronous” processing. In some embodiments, asynchronous processing may facilitate or expedite the delivery or download of order data information from system 300 to the tenant organization, and processing of the same, for example, to complete the order fulfillment.

Asynchronous data preparation engine 310 may include, provide, or support features, functions, or algorithms for asynchronous order export processing for one or more tenant organizations that may desire or want such feature. In some embodiments, the asynchronous data preparation engine 310 can initiate the asynchronous order export processing, and in conjunction with the data processing engine 304 perform the processing. In some embodiments, asynchronous data preparation engine 310 may monitor each of the tenant organizations' behaviors and activities. In some embodiments, for example, the asynchronous data preparation engine 310 offers the option of enabling the asynchronous data processing feature to each of the tenant organizations utilizing the shared platform 116, for example, after its first export data request is received. In some examples, the asynchronous data preparation engine 310 may offer the option of enabling the asynchronous data processing feature if the asynchronous data preparation engine 310 determines that using the asynchronous data processing feature would be beneficial to a tenant organization. In some examples, the asynchronous data preparation engine 310 may determine that using the asynchronous data processing feature would be beneficial or optimal to a tenant organization, for example, if the tenant organization consistently receives a large number of orders in a relatively short amount of time.

Smart switch engine 308 may include or be provided with functions and procedures to activate or deactivate a feature or function, such as, for example, the asynchronous data processing feature. In some embodiments, the smart switch engine 308 works in cooperation or conjunction with the asynchronous data preparation engine 310 to enable and maintain, monitor, or disable the provision of the asynchronous data processing feature to one or more tenant organizations using the shared platform 116 based on the preferences of each tenant organization, as further described below. In some embodiments, smart switch engine 308 may store, for each of tenant organization, information or data as to whether the tenant organization prefers to use the asynchronous data processing feature. In some embodiments, this information can be stored in database 302 and may comprise state information with respect to whether the smart switch engine 308 is enabled or disabled for the feature. When the smart switch engine 308 is enabled, then the stored preference of the tenant organization is to use the feature. When the smart switch engine 308 is disabled, then the stored preference of the tenant organization is to not use the feature. Thus, in some embodiments, a tenant organization's preference to use the asynchronous data processing feature may be determined by a state of the smart switch engine 308 for the tenant organization. (i.e., whether the smart switch engine 308 is enabled or disabled for the tenant organization).

In some embodiments, for each tenant organization for which the smart switch is enabled for a particular feature (e.g., asynchronous data processing), the smart switch engine 308 may also maintain or keep track of a time interval (e.g., 24 hours) during which the behavior or activity of the tenant organization with respect to system 300 is monitored. If the tenant organization utilizes the feature within the time interval, then the smart switch engine 308 remains enabled for the feature, and system 300 continues to perform or provide the feature for the tenant organization. If, however, the tenant organization does not utilize the feature within the time interval, then the smart switch engine 308 is disabled for the feature, and system 300 does not perform or provide the feature for the tenant organization, unless the tenant organization provides an indication at some point in the future that it prefers to use the feature again.

In the example of the asynchronous data processing feature, if the smart switch engine 308 is enabled for a tenant organization, system 300 monitors for whether the tenant organization sends a request to export data within the predetermined interval. If not, then the feature for the tenant organization will be deactivated (i.e., the smart switch engine 308 is disabled for the tenant organization for that feature). However, the tenant organization may be given another opportunity to use the feature in the future, and if the tenant organization so elects, then the smart switch engine 308 is again enabled for the feature.

Export engine 312 may include, provide, or support functions and procedures to export the order data or information (raw or processed). In some embodiments, export engine 312 is responsive to requests made by tenant organizations using the shared platform to support electronic commerce. For example, each such tenant organization may from time to time submit or send requests to system 300 in order to retrieve or download data or information regarding orders that have been placed for its products or services. In the example of the asynchronous data processing feature, export engine 312 may call or check with smart switch engine 308 to determine if the feature is enabled for a tenant organization. If so, export engine 312 may fetch or retrieve the processed order data from database 302 and export the XML report of the order to the requesting tenant organization. If the feature is not enabled for the tenant organization, then export engine 312 may retrieve the raw order data from database 302 and export to the tenant organization.

API 314 provides or supports an interface through which one or more users or systems can interact or interface with system 300. These can include, for example, one or more tenant organizations using the shared platform to support, host, or provide electronic commerce to offer or sell goods or services, one or more shoppers browsing, viewing, and placing orders for such goods and services, and their respective user systems 112. In some embodiments, the system 300 may receive requests to export data through API 314. In some examples, API 314 may include or be provided with interface applications of a shared platform such as API 232 and UI 230 as described in FIGS. 1 and 2.

According to some embodiments, all or a portion of system 300 may run on or be incorporated in system 116, with tenant data storage 122, system data storage 124, program code 126, process space 128 of FIGS. 1 and 2. In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form.

In some examples, if the smart switch engine 308 of the tenant organization is not enabled, the shared platform does not use its cloud computing, processing resources to process the second order of the tenant organization. This frees up those resources on the shared platform for other purposes.

In some examples, some tenant organizations may wish to use a feature or function provided by the shared platform, such as, XML export order to process their data orders. In some examples, some tenant organizations may elect or choose not to use a feature or function provided by the shared platform, but instead utilize their own systems and procedures instead.

For example, if a customer orders a pair of shoes from a tenant organization's online store, the pair of shoes order data is stored in databased 302 and if it is determined that the tenant organization wishes to use the data processing engine 304, data processing engine 304 processes the order and generating a XML report of the order that may include specifications about the ordered pair of shoes, the customer's address, the tenant organization's warehouse that has this pair of shoes in inventory and/or the like. And after the tenant organization sends an export data request, the XML report of the pair of shoes order is then transferred or passed to the tenant organization's warehouse to fetch the ordered shoes and prepare them for shipping to the customer's address.

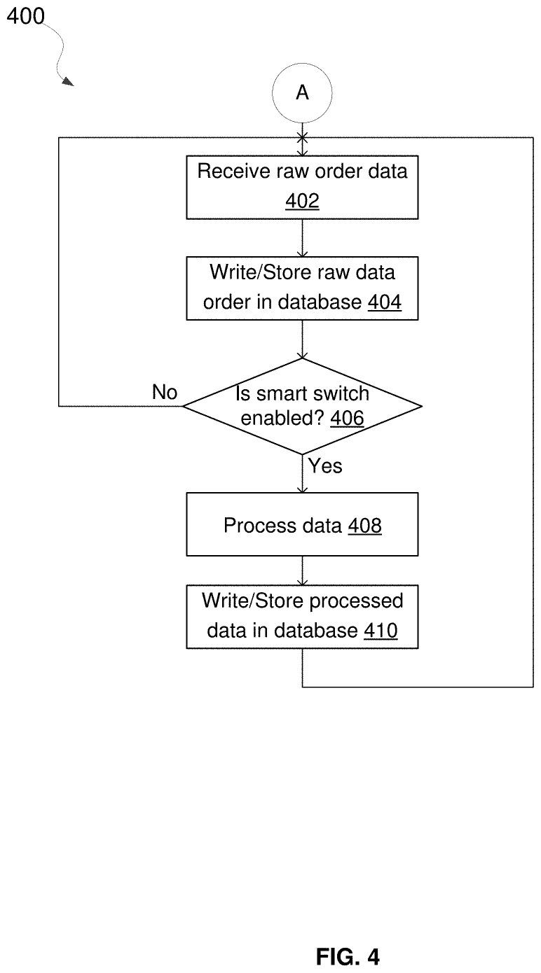

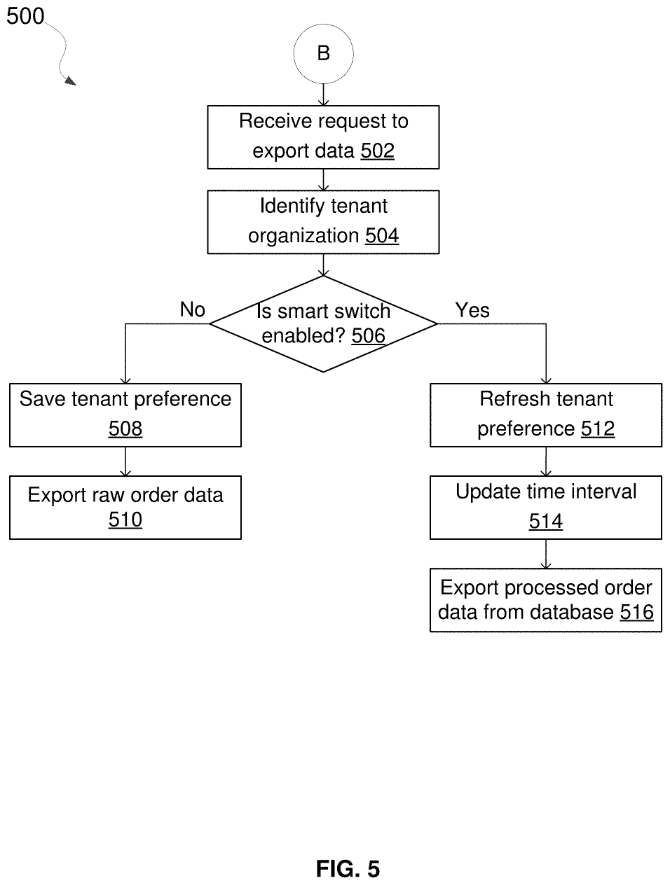

FIGS. 4 and 5 illustrate simplified diagrams of a method or process flow 400 and 500 for managing preferences of multiple organizations utilizing a shared platform (e.g., tenant organizations of a multi-tenant shared platform or CRM system such that described with reference FIGS. 1 and 2), according to some embodiments. In some embodiments, as shown, this process flow provides and maintains a self-activating asynchronous data processing feature to tenant organizations.

According to some embodiments, one or more of the processes 402-410 of process flow 400 and processes 502-516 of process flow 500 may be implemented, at least in part, in the form of executable code stored on non-transitory, tangible, machine-readable media that when run by one or more processors may cause the one or more processors to perform one or more of the processes 402-410 or processes 502-516. According to some embodiments, process flow 400 and process flow 500 can be performed by one or more computing devices or components illustrated or described with respect to the systems 100-300 of FIGS. 1 to 3, respectively including database 302, data processing engine 304, receive order engine 306, smart switch engine 308, asynchronous data preparation engine 310, export engine 312, and API 314. Aspects of the processes 402-410 of process flow 400 and processes 502-516 of process flow 500 have been covered in the description for FIGS. 1, 2, and 3; and additional aspects are provided herein. According to some embodiments, all or a portion of the process flow 400 and process flow 500 may be performed to provide or support the provision of various features or functions of the shared platform, such as, for example, the self-activating asynchronous data processing feature, one or more of the tenant organizations using the shared platform.

Referring to FIG. 4, according to some embodiments, process flow 400 may be performed by system 300 for each tenant organization using the shared platform 116 to support e-commerce services. In some examples, for each such tenant organization, the process flow is performed for the one or more orders made to the shared platform 116.

At a process 402, the system 300, for example, at receive order engine 306, receives order data from a shopper to tenant organization's e-commerce site. The order data may be in unprocessed or raw form and may relate to orders for the purchase of products or services offered by the tenant organization. In some examples, the shopper may use a computing device (e.g., user system 112 such as that described with reference to FIGS. 1 and 2) to view and place an order for the product or service. In some examples, the receive order engine 306 receives the order of the shopper when the shopper enters or places the order along with payment information and the system 300 has verified and captured the payment. At a process 404, the receive order engine 306 writes or stores the raw data order, for example, in the database 302.

At a decision process 406, system 300 determines whether the tenant organization prefers or has activated a particular feature, such as asynchronous processing of the order data. In some embodiments, this determination can be made by receive order engine 306 in cooperation with asynchronous data preparation engine 310 querying the smart switch engine 308 regarding status. In some examples, for the initial order or orders made to the tenant organization's e-commerce site, before system 300 receives an export data request from the tenant organization, the particular feature is disabled by default. The tenant organization, as further described herein, may elect or choose to use the feature, for example, in connection with a request to export the order data. The tenant organization's preference as to the feature may then be stored in database 302, for example, as a state of the smart switch engine 308. Thus, when the receive order engine 306 receives an order data of the tenant organization, the tenant organization's preference for the feature may be referenced or accessed from database 302.

If at decision process 406, the system 300 determines that the tenant organization has enabled or activated the feature, for example, by calling or referencing the smart switch engine 308, the process flow 400 performs processes 408 and 410 for the feature (e.g., asynchronous data processing). In this case, resources of the shared platform (e.g., processing, storage, or network resources) may be utilized to handle or carry out the tenant organization's preference, e.g., for asynchronous data processing feature provided by the shared platform.

At a process 408, the system 300 performs processing on the raw data related to the order made in connection to the tenant organization's e-commerce service. In some examples, the data processing engine 304 retrieves the raw order data from database 302, and working with asynchronous data preparation engine 310, processes the raw order data of the tenant organization, for example by generating an XML report or document of the order data. In some examples, the XML report of the order may include, for each shopper, information about the order, the shopper's shipping address, the order shipping method, the tenant organization, and/or the like. For example, if a shopper orders a pair of shoes from a tenant organization's e-commerce website, the XML report of the order may include specifications about the ordered pair of shoes (e.g., size, color, etc.) and/or the like.

At a process 410, the system 300 stores or writes the processed order data, for example, in database 302. In some examples, this can be performed by the asynchronous data preparation engine 310, in cooperation with the data processing engine 304. In this case, the order data is processed asynchronously—i.e., before the tenant organization sends an export data request. Thereafter, process flow 400 returns to process 402 where system 300 awaits the receipt of data or information for the next order or orders to be made by one or more shoppers at the tenant organization e-commerce site.

Referring back to decision process 406, if the system 300 determines that the tenant organization has not activated or enabled the feature (e.g., asynchronous data processing), the data processing engine 304 does not process the raw data order related to the tenant organization. Thus, the raw data order is maintained in database 302. In this case, the resources of the shared platform (e.g., processing, networking, storage) are not used for providing the feature (e.g., of asynchronous data processing) to the tenant organization; instead, the order data is processed before the tenant. Thereafter, process flow 400 returns to process 402 where system 300 awaits the receipt of data or information for the next order or orders to be made by one or more shoppers at the tenant organization e-commerce site.

Referring to FIG. 5, according to some embodiments, process flow 500 may be performed by system 300 for each tenant organization using the shared platform 116 to support e-commerce services. According to some embodiments, process flow 500 may be performed by system 300 for each feature or function provided by the system. In some examples, for each such tenant organization, the process flow 500 is performed for requests to export information or data of the order or orders made to the shared platform 116.

According to some embodiments, one or more of the processes 502-516 of process flow 500 may be implemented, at least in part, in the form of executable code stored on non-transitory, tangible, machine-readable media that when run by one or more processors may cause the one or more processors to perform one or more of the processes 502-516. According to some embodiments, process flow 500 can be performed by one or more computing devices illustrated or described with respect to the systems 100-300 of FIGS. 1, 2, and 3, respectively including database 302, data processing engine 304, receive order engine 306, smart switch engine 308, asynchronous data preparation engine 310, export engine 312, and API 314. Aspects of the processes 502-516 of process flow 500 have been covered in the description for FIGS. 1, 2, and 3; and additional aspects are provided herein. According to some embodiments, all or a portion of the process flow 500 may be performed to manage a preference of the tenant organization using the shared platform for one or more features or functions, such as asynchronous data processing of the order information.

At a process 502, the system 300, for example at export engine 312, receives a request to export order data from the respective tenant organization. In some embodiments, the export engine 312 may receive the export data request via network 114, API 232, and API 314 such as that described with reference to FIGS. 1-3. The requesting tenant organization seeks this order information or data so that it can process the orders, for example, for fulfillment and payment of the same.

In some examples, the tenant organization may send export data requests at different time intervals depending on the level of activity and the orders it receives from its shoppers over a period of time. For example, during a particularly busy sales season (such as the Christmas Holidays), the respective tenant organization may send export data requests more frequently (e.g., every few hours). In another example, during other times when shoppers are not as active, the respective tenant organization may send the export data requests less frequently (e.g., every day). In some embodiments, the export data request may include information about the tenant organization's preference for one or more features (e.g., export data processing). In some embodiments, the export data request may include or be marked with a timestamp which specifies the time, time zone, date, etc. such as 00:10:00 PT Mar. 5, 2019.

At a process 504, system 300 identifies the tenant organization which sent the export data request. In some embodiments, this can be performed by the export engine 312.

Once the tenant organization has been identified, the system 300 may determine the preference of the tenant organization with respect to one or more features or functions of the shared platform. In the example of asynchronous order processing, the export engine 312 may call the smart switch engine 308 or asynchronous data preparation engine 310 to determine whether the tenant organization prefers to use that feature, for example, based on the tenant organization's actions with respect to the previous orders and export data request, the current status of the smart switch for the feature, and/or the tenant organization's preference included in the export data request. In some examples, system 300 may also determine a timestamp of the export data request.

At a decision process 506, the smart switch engine 308 determines whether the feature (e.g., asynchronous data processing) has been enabled for the tenant organization; in other words, what is the tenant organization's preference with respect to the feature.

In some examples, for the first export data request received from the tenant organization, the feature for the tenant organization may be turned off, i.e., the smart switch of the feature for the tenant organization may be initially disabled. But if the tenant organization uses certain functionality, such as export order data processing, thus indicating a preference for asynchronous processing for future export requests, the system 300 will enable the smart switch engine 308 for that feature, and save information for such preference in database 302. Thus, for subsequent export data requests received from the tenant organization, the state of the smart switch (e.g., enabled or disabled) provides an indicator of the tenant organization's preference for such feature. The tenant organization's preference information or data can then be referenced for subsequent orders and requests made by the tenant organization. The system 300 will automatically provide the desired functionality or feature, for example, by performing asynchronous export data processing on the next batch of orders received for the tenant organization according to the process flow 400 of FIG. 4. The processed order data is stored into database 302.

In some embodiments, if the smart switch is enabled for the first export data request, system 300 may initiate a time interval (e.g., 24 hours) for the feature with respect to that tenant organization. In some embodiments, the time interval is initiated or triggered from the timestamp of the export data request, for example, by the asynchronous data preparation engine 310 or smart switch engine 308. The tenant organization is expected to send the next export data request before the time interval ends if the feature is to continue the tenant organization. If the tenant organization does not send the next export data request before the time interval lapses—indicating that the tenant organization may not prefer to use the feature—then system 300 may disable the smart switch for that feature.

If at decision process 506, the smart switch engine 308 determines that the smart switch is not enabled for the feature (e.g., asynchronous data processing), meaning that the tenant organization does not prefer (or no longer prefers) to use the feature, process flow 500 performs processes 508 and 510. In some examples, the tenant organization may have its own data processing and procedures and does not prefer to use the one or more features provided by the shared platform. In some examples, the tenant organization may have previously used the feature provided by the shared platform, but at some point, decided that it prefers not to use this feature. Thus, system 300 disables or deactivates the smart switch of the particular feature for the tenant organization and will not perform the feature for the subsequent orders made to the tenant organization's e-commerce site. In the example of the asynchronous data processing feature, for subsequent orders made to the tenant organization's e-commerce site, system 300 will not perform asynchronous export data processing. The system 300 is reset as to that tenant organization and that feature. However, the tenant organization may indicate its preference and activate this feature in the next export data request cycle.

At process 508, system 300 saves or stores the tenant organization's preference as to the feature, for example, not performing or activating the asynchronous export data processing feature, into database 302. In some embodiments, the information or data about the tenant organization's preference is saved or stored in database 302 by the smart switch engine 308. The preference information or data can then be referenced for subsequent orders and requests made by the tenant organization. In this case, the smart switch engine 308 of the tenant organization remains disabled for the feature. The resources of the shared platform (e.g., processing, networking, storage) have not been used for providing the feature (e.g., of asynchronous data processing) for the tenant organization. Thus, the raw data for the order or orders is not processed.

At process 510, the export engine 312 fetches the raw data for the requested order or orders and exports it to the tenant organization. In some examples, the export engine 312 exports the raw order data to the merchant through API 314 and network 114 such as that described in FIGS. 1-3. In this case, the tenant organization may use its own data processing systems and procedures to process the data order. Thereafter, system 300 may await to receive the next order or orders to be made by one or more shoppers at the tenant organization's e-commerce site.

Referring back to decision process 506, if the smart switch engine 308 determines that the smart switch is enabled for the feature (e.g., asynchronous data processing), meaning that the tenant organization prefers (or still prefers) to use the feature, process flow 500 performs processes 512-516.

In some examples, if the tenant organization sends a subsequent export data request before the time interval of the feature expires, it is an indication of the tenant organization's preference (or continued preference) to use the particular feature (e.g., of asynchronous export data processing). Thus, at process 512, system 300 refreshes or maintains the preference, for example, by enabling (or continuing to enable) the smart switch engine 308 for this feature for the tenant organization.

At process 514, the asynchronous data preparation engine 310 in cooperation with the smart switch engine 308 updates the time interval of the feature (e.g., asynchronous data processing) for the tenant organization, for example, based on the timestamp of the export data request and the time interval of the feature. For example, the time interval of the feature for the tenant organization is updated and reset (e.g., to a new 24-hour interval). Information for the new or updated time interval is saved into database 302.

At process 516, the export engine 312 fetches or retrieves the processed order data, e.g., from database 302, and exports it to the respective tenant organization. In this case, the resources of the shared platform (e.g., processing, networking, storage) have been utilized to handle or carry out the tenant organization's preference, e.g., for asynchronous data processing feature provided by the shared platform. The tenant organization can use the processed order data to, for example, fulfill the orders to the respective shoppers. In some embodiments, the export engine 312 exports the processed order data similar to the raw order data as in process 510. Thereafter, system 300 may await to receive the next order or orders be made by one or more shoppers at the tenant organization e-commerce site.

In some embodiments, system 300 may perform process flow 400 in FIG. 4 and process flow 500 in FIG. 5 for multiple features or functions, wherein each feature or function may be associated with a separate smart switch (e.g., smart switch engine 308), a processing engine (e.g., asynchronous data preparation engine 310), and a time interval.

In some embodiments, one or more actions or operations illustrated or described with respect to processes 402-410 in FIG. 4 and processes 502-516 in FIG. 5 may be performed for managing preferences of multiple tenant organizations utilizing a shared platform 116. It is also understood that additional processes may be performed before, during, or after processes 402-410 and 502-516 discussed above. It is also understood that one or more of the processes of process flows 400 and 500 described herein may be omitted, combined, or performed in a different sequence as desired.

The systems and methods described herein provide or enable features or functions to some tenant organizations using the shared platform, thereby providing an enhanced or better experience, while not providing or enabling the features or functions to other tenant organizations that do not use them, thereby freeing up resources (e.g., processing, networking, or storage) of the shared platform other purposes.

Memory may be used to store software executed by computing devices and/or one or more data structures used during operation of computing devices. Memory may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Unless specifically stated otherwise as apparent from the following discussion, it is appreciated that throughout the description, discussions utilizing terms such as “determining,” “obtaining,” “inserting,” “executing,” “receiving,” “transmitting,” “identifying,” “generating,” “determining,” “traversing,” and the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain examples of the present disclosure also relate to an apparatus for performing the operations herein. This apparatus may be constructed for the intended purposes, or it may include a general-purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Although illustrative embodiments have been shown and described, a wide range of modifications, changes, and substitutions is contemplated in the foregoing disclosure and in some instances, some features of the embodiments may be employed without a corresponding use of other features. One of ordinary skill in the art would recognize many variations, alternatives, and modifications. Thus, the scope of the disclosure should be limited only by the following claims, and it is appropriate that the claims be construed broadly and in a manner consistent with the scope of the embodiments disclosed herein.

What is claimed is:

1. A system for managing preferences of multiple tenant organizations utilizing a shared computer platform, the system comprising:
a memory storing machine executable code; and
one or more processors coupled to the memory and configurable to execute the machine executable code to cause the one or more processors to:
receive a current data item;
identify one of the multiple tenant organizations that is associated with the current data item;
determine whether the identified tenant organization utilizes a process that can be performed by the shared computer platform on the current data item;
if the identified tenant organization utilizes the process:
cause the shared computer platform to perform the process on the current data item to generate processed data;
enable a preference for the shared computer platform to perform the process on subsequent data items received by the system and associated with the identified tenant organization; and
maintain the preference for each such subsequent data item as long as the identified tenant organization utilizes the process within a predetermined interval after a prior data item.

2. The system of claim 1, wherein the shared computer platform is used to support electronic commerce.

3. The system of claim 2, wherein the identified tenant organization is acting as a merchant.

4. The system of claim 2, wherein the current data item comprises data for an order placed on the shared computer platform.

5. The system of claim 4, wherein the process comprises a computerized order preparation process.

6. The system of claim 5, wherein the preference comprises a preference to perform the computerized order preparation process before the identified tenant organization requests the current data item.

7. The system of claim 1, wherein the memory and the one or more processors are part of the shared computer platform.

8. A method for managing preferences of multiple tenant organizations utilizing a shared computer platform, the method comprising:
receiving, at one or more processors, a current data item;
identifying, at the one or more processors, one of the multiple tenant organizations that is associated with the current data item;
determining, at the one or more processors, whether the identified tenant organization utilizes a process that can be performed by the shared computer platform on the current data item;
if the identified tenant organization utilizes the process:
causing, at the one or more processors, the shared computer platform to perform the process on the current data item to generate processed data;
enabling, at the one or more processors, a preference for the shared computer platform to perform the process on subsequent data items received at the one or more processors and associated with the identified tenant organization; and
maintaining, in a memory, the preference for each such subsequent data item as long as the identified tenant organization utilizes the process within a predetermined interval after a prior data item.

9. The method of claim 8, wherein the shared computer platform is used to support electronic commerce.

10. The method of claim 9, wherein the identified tenant organization is acting as a merchant.

11. The method of claim 9, wherein the current data item comprises data for an order placed on the shared computer platform.

12. The method of claim 11, wherein the process comprises a computerized order preparation process.

13. The method of claim 12, wherein the preference comprises a preference to perform the computerized order preparation process before the identified tenant organization requests the current data item.

14. The method of claim 8, wherein the memory and the one or more processors are part of the shared computer platform.

15. A non-transitory machine-readable medium comprising executable code which when executed by one or more processors associated with a computer are adapted to cause the one or more processors to perform a method for managing preferences of multiple tenant organizations utilizing a shared computer platform, the method comprising:
receiving a current data item;
identifying one of the multiple tenant organizations that is associated with the current data item;
determining whether the identified tenant organization utilizes a process that can be performed by the shared computer platform on the current data item;
if the identified tenant organization utilizes the process:
causing the shared computer platform to perform the process on the current data item to generate processed data;
enabling a preference for the shared computer platform to perform the process on subsequent data items received by the one or more processors and associated with the identified tenant organization; and
maintaining the preference for each such subsequent data item as long as the identified tenant organization utilizes the process within a predetermined interval after a prior data item.

16. The non-transitory machine-readable medium of claim 15, wherein the shared computer platform is used to support electronic commerce.

17. The non-transitory machine-readable medium of claim 16, wherein the identified tenant organization is acting as a merchant.

18. The non-transitory machine-readable medium of claim 16, wherein the current data item comprises data for an order placed on the shared computer platform.

19. The non-transitory machine-readable medium of claim 18, wherein the process comprises a computerized order preparation process.

20. The non-transitory machine-readable medium of claim 19, wherein the preference comprises a preference to perform the computerized order preparation process before the identified tenant organization requests the current data item.

21. The non-transitory machine-readable medium of claim 15, wherein the one or more processors are part of the shared computer platform.
